(19) United States
(12) Patent Application Publication
(10) Pub. No.: US 2023/0327364 A1
(43) Pub. Date: Oct. 12, 2023

(54) TYPE-C FEMALE SOCKET IRON CASE

(71) Applicant: AMPHENOL EAST ASIA ELECTRONIC TECHNOLOGY (SHEN ZHEN) CO., LTD., Shenzhen (CN)

(72) Inventors: Fei WU, Shenzhen (CN); Zhimin QIN, Shenzhen (CN)

(21) Appl. No.: 17/718,954

(22) Filed: Apr. 12, 2022

(51) Int. Cl. H01R 13/516; H01R 24/62

(52) U.S. Cl. CPC H01R 13/516; H01R 24/62; H01R 2107/00

(57) ABSTRACT

A Type-C female socket iron case includes an iron case main body plugged with a male socket; the iron case main body having one end formed as a square cylindrical case, a middle bore formed on two sides in the middle of an upper surface of the square cylindrical case on two sides thereof; a first weld leg disposed on two ends on both sides of the square cylindrical case corresponding to the middle hole; an extension part extending from a lower surface of the square cylindrical case on another end; a side wall disposed on two sides of the extension part, a second weld leg disposed on an end part of each side wall; two elastic arms disposed on the lower surface of the square cylindrical case; each elastic arm formed in arc shape for increasing insertion and withdrawal force.

### BACKGROUND OF THE INVENTION

### 1. Field of the Invention

The present invention relates to connectors, and more particularly, to a metal contact member with elastic arm for connectors.

### 2. Description of the Related Art

With science and technology advancement, connectors have a plug and play function, so as to be widely used. The iron case of the female socket of conventional connectors is usually formed of an upper and a lower elastic plates or convex hulls formed by metal parts. However, the elastic plates only provide the contact function and do not provide an insertion and withdrawal force. Current products on the market are unable to meet higher requirements.

### SUMMARY OF THE INVENTION

The present invention aims at increasing the insertion and withdrawal force during the plugging operation between the female socket and the male sockets, and simultaneously achieving a structural optimization.

For achieving the aforementioned objectives, a Type-C female socket iron case is provided, comprising an iron case main body, the iron case main body being configured to be plugged with a male socket;
the iron case main body having one end formed as a square cylindrical case, a middle bore being formed on two sides in the middle of an upper surface of the square cylindrical case on two sides thereof, respectively; a first weld leg being disposed on two ends on both sides of the square cylindrical case corresponding to the middle hole, respectively; an extension part extending from a lower surface of the square cylindrical case on another end of the iron case main body; a side wall being disposed on two sides of the extension part, respectively, with a second weld leg disposed on an end part of each side wall;
at least two elastic arms being disposed on the lower surface of the square cylindrical case; each elastic arm being formed in an arc shape toward an inner cavity of the square cylindrical case for increasing an insertion and withdrawal force.

Preferably, the insertion and withdrawal force of the elastic arm is an insertion and withdrawal force of 4 to 6 Newton when male head and female head connectors are plugged.

Preferably, the elastic arm is arranged in parallel with two sides of the square cylindrical case.

Preferably, the first weld leg comprises an engagement notch on an end thereof; the second weld leg comprises an engagement notch on an end thereof.

Preferably, a tail part of the extension part is bent upward.

Preferably, at least two engagement points are disposed on the upper surface of the extension part; the engagement point is internally convex, so as to increase a stableness of a combination with a male socket.

With such configuration, the present invention achieves following advantages.

Compared with prior arts, the Type-C female socket iron case of the present invention applies a design of elastic arm. With the pushing force of the convex elastic arm, the insertion and withdrawal force of Type-C female and male sockets combination is improved. The iron case is bent by formation of a metal plate material, so as to improve the insertion and withdrawal force of Type-C female and male sockets combination, and simultaneously fulfill Test Identification (TID) certification requirement. The present invention fulfills the TID certification requirement and increases the insertion and withdrawal force without Electro Magnetic Compatibility (EMC). Therefore, the present invention improves the insertion and withdrawal force of Type-C female and male sockets combination through the elastic arm of the iron case, and fulfills the TID requirement.

### BRIEF DESCRIPTION OF THE DRAWINGS

FIG. 1 is a first perspective view of the Type-C female socket iron case in accordance with an embodiment of the present invention.

FIG. 2 is a second perspective view of the Type-C female socket iron case in accordance with an embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

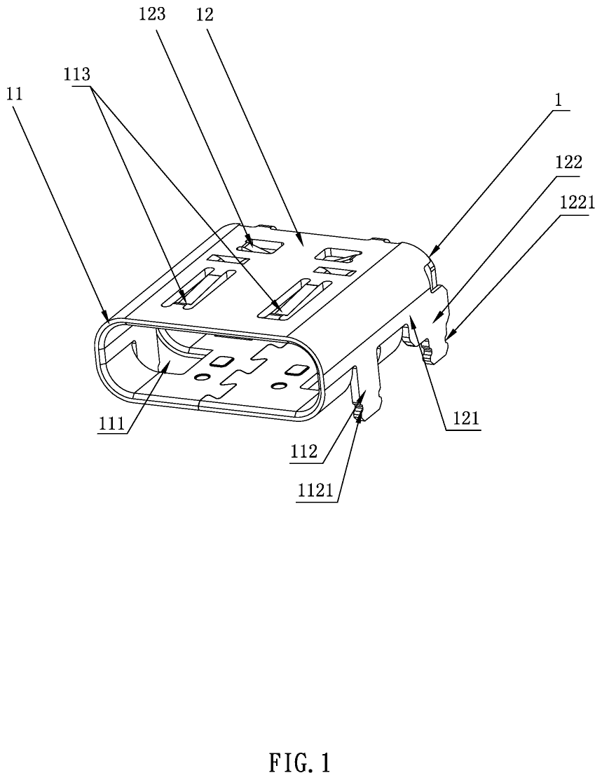

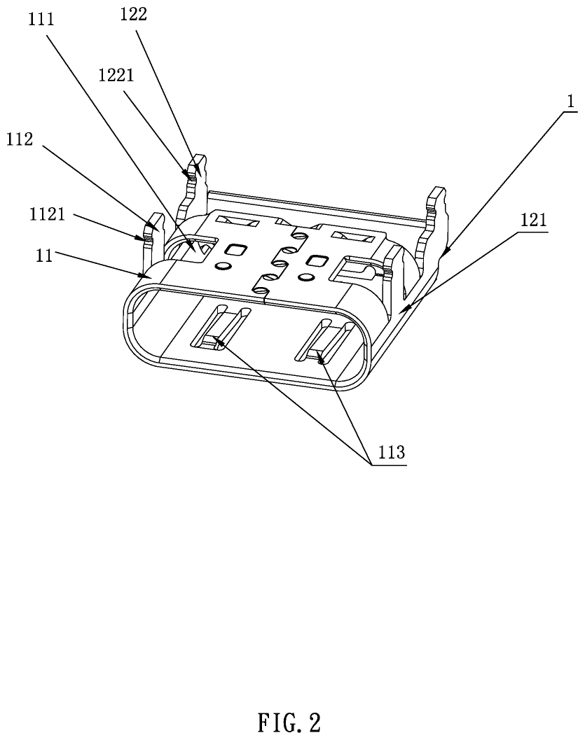

Referring to FIG. 1 and FIG. 2, the present invention is described in detail below; however, such content is not intended to limit the present invention.

### Embodiment 1

Referring to FIG. 1 and FIG. 2, a Type-C female socket iron case comprises an iron case main body 1, the iron case main body 1 being configured to be plugged with a male socket; the iron case main body 1 having one end formed as a square cylindrical case 11, a middle bore 111 being formed on two sides in the middle of an upper surface of the square cylindrical case 11 on two sides thereof, respectively; a first weld leg 112 being disposed on two ends on both sides of the square cylindrical case 11 corresponding to the middle hole 111, respectively; an extension part 12 extending from a lower surface of the square cylindrical case 11 on another end of the iron case main body 1; a side wall 121 being disposed on two sides of the extension part 12, respectively, with a second weld leg 122 disposed on an end part of each side wall 121;
at least two elastic arms 113 being disposed on the lower surface of the square cylindrical case 11; each elastic arm 113 being formed in an arc shape toward an inner cavity of the square cylindrical case 11 for increasing an insertion and withdrawal force.

The insertion and withdrawal force of the elastic arm 113 is an insertion and withdrawal force of 4 to 6 Newton when male head and female head connectors are plugged. The elastic arm 113 is arranged in parallel with two sides of the square cylindrical case 11. The first weld leg 112 comprises an engagement notch 1121 on an end thereof; the second weld leg 122 comprises an engagement notch 1221 on an end thereof. A tail part of the extension part 12 is bent upward. At least two engagement points 123 are disposed on the upper surface of the extension part 12. The engagement point 123 is internally convex, so as to increase a stableness of a combination with a male socket.

Referring to FIG. 1 and FIG. 2, the practical embodiment of the Type-C female socket iron case is described below. The iron case main body 1 is plugged with a male socket. With the pushing force of the convex elastic arm, the insertion and withdrawal force of Type-C female and male sockets combination is improved, so as to achieve the objectives of the present invention, improving the insertion and withdrawal force of Type-C female and male sockets combination and simultaneously fulfilling Test Identification (TID) certification requirement without Electro Magnetic Compatibility (EMC). Accordingly, the present invention improves the insertion and withdrawal force of Type-C female and male sockets combination through the elastic arm of the iron case, and fulfills the TID requirement.

Although particular embodiments of the invention have been described in detail for purposes of illustration, various modifications and enhancements may be made without departing from the spirit and scope of the invention. Accordingly, the aforementioned embodiments are, in all respects, illustrative and not exclusive. All changes within the scope of the present invention or equivalent to the present invention are included by the present invention.

What is claimed is:

1. A Type-C female socket iron case, comprising an iron case main body, the iron case main body being configured to be plugged with a male socket;
wherein, the iron case main body has one end formed as a square cylindrical case, a middle bore is formed on two sides in the middle of an upper surface of the square cylindrical case on two sides thereof, respectively; a first weld leg is disposed on two ends on both sides of the square cylindrical case corresponding to the middle hole, respectively; an extension part extends from a lower surface of the square cylindrical case on another end of the iron case main body; a side wall is disposed on two sides of the extension part, respectively, with a second weld leg being disposed on an end part of each side wall;
at least two elastic arms are disposed on the lower surface of the square cylindrical case; each elastic arm is formed in an arc shape toward an inner cavity of the square cylindrical case for increasing an insertion and withdrawal force.

2. The Type-C female socket iron case of claim 1, wherein the insertion and withdrawal force of the elastic arm is an insertion and withdrawal force of 4 to 6 Newton when male head and female head connectors are plugged.

3. The Type-C female socket iron case of claim 1, wherein the elastic arm is arranged in parallel with two sides of the square cylindrical case.

4. The Type-C female socket iron case of claim 1, wherein the first weld leg comprises an engagement notch on an end thereof; the second weld leg comprises an engagement notch on an end thereof.

5. The Type-C female socket iron case of claim 1, wherein a tail part of the extension part is bent upward.

6. The Type-C female socket iron case of claim 1, wherein at least two engagement points are disposed on the upper surface of the extension part; the engagement point is internally convex, so as to increase a stableness of a combination with a male socket.
